(19) United States
(12) Patent Application Publication
(10) Pub. No.: US 2025/0251773 A1
(43) Pub. Date: Aug. 7, 2025

(54) ESYNC HYBRID MODE

(71) Applicant: QUALCOMM Incorporated, San Diego, CA (US)

(72) Inventors: Kit Fong NG, Thornhill (CA); Samson KIM, Richmond Hill (CA)

(21) Appl. No.: 19/046,465

(22) Filed: Feb. 5, 2025

Related U.S. Application Data
(60) Provisional application No. 63/551,029, filed on Feb. 7, 2024.

(51) Int. Cl. G06F 1/3234; G06F 1/3218; G06F 1/3287

(52) U.S. Cl. CPC G06F 1/3243; G06F 1/3218; G06F 1/3287

(57) ABSTRACT

This disclosure provides systems, devices, apparatus, and methods, including computer programs encoded on storage media, for ESYNC hybrid mode. A processor determines that an AP is to transition from a first power mode to a second power mode based on a change in a refresh rate of a display panel. The processor switches, based on the determination and during a transmission of a continuous external HSYNC signal, a source of a clock associated with the external HSYNC signal from being generated via PLL clock to being generated via an RC oscillator clock.

### CROSS REFERENCE TO RELATED APPLICATION(S)

This application claims the benefit of and priority to U.S. Provisional Application Ser. No. 63/551,029, entitled “ESYNC HYBRID MODE” and filed on Feb. 7, 2024, which is expressly incorporated by reference herein in its entirety.

### TECHNICAL FIELD

The present disclosure relates generally to processing systems, and more particularly, to one or more techniques for display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for display processing may not address certain characteristics of display panels that support a wide range of variable refresh rates. There is a need for improved techniques pertaining to display panels that support a wide range of variable refresh rates.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus for display processing are provided. The apparatus includes a memory; and a processor coupled to the memory and, based on information stored in the memory, the processor is configured to: determine that an application processor (AP) is to transition from a first power mode to a second power mode based on a change in a refresh rate of a display panel; and switch, based on the determination and during a transmission of a continuous external horizontal synchronization (HSYNC) signal, a source of a clock associated with the external HSYNC signal from being generated via a phased lock loop (PLL) clock to being generated via a resistor-capacitor (RC) oscillator clock.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example display framework including a display processor and a display in accordance with one or more techniques of this disclosure.

FIG. 4 is a diagram illustrating an example of a display interface between an application processor (AP) and a display driver integrated circuit (DDIC) in accordance with one or more techniques of this disclosure.

FIG. 5 is a diagram illustrating an example of a display interface controller in an AP in accordance with one or more techniques of this disclosure.

FIG. 6 is a diagram illustrating an example of a frame transfer diagram without hybrid mode operation in accordance with one or more techniques of this disclosure.

FIG. 7 is a diagram illustrating an example of a frame transfer diagram with hybrid mode operation in accordance with one or more techniques of this disclosure.

FIG. 8 is a call flow diagram illustrating example communications between an AP and a DDIC in accordance with one or more techniques of this disclosure.

FIG. 9 is a flowchart of an example method of display processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

Some display panels (e.g., low-temperature polycrystalline oxide (LTPO) display panels) may support the ability to dynamically switch between refresh rates. For instance, when displaying a static image, a display panel may reduce a refresh rate of the display panel to a minimum refresh rate (e.g., 1 Hz), which may conserve battery power. A display processor associated with a display panel may utilize a clock in order to synchronize different parts of circuits associated with the display panel. In an example, a source of the clock may be a phased lock loop (PLL). A PLL may refer to a control system that generates an output signal that has a phase related to a phase of an input signal. In an example, for a display processor, a clock (e.g., a clock from a PLL) may dictate how fast pixels of a frame may be transmitted. While a PLL may be associated with a relatively high clock accuracy, the PLL may also be associated with a relatively high power consumption. Thus, keeping a PLL turned on while a display processor is not transferring display data to a display panel may be associated with increased power consumption.

Various technologies pertaining to an external HSYNC (ESYNC) hybrid mode are described herein. In an example, an apparatus may be configured to determine that an application processor (AP) is to transition from a first power mode to a second power mode based on a change in a refresh rate of a display panel. An AP may refer to a set of processors, for example a system that includes different types of processors for different types of application. A display processor may be part of an application processor, where the display processor may act as a host processor that is responsible for transmitting display frames to a display device. An application processor may also be referred to as a host processor. A power mode may include a mode that consumes a certain amount of power over a given period of time. The first power mode and second power mode may be different. For example, the first power mode may consume a relatively larger amount of power over a defined period of time than the second power mode over the same period of time, or the first power mode may consume a relatively smaller amount of power over a given period of time than the second power mode over the same period of time. The apparatus may be configured to switch, based on the determination and during a transmission of a continuous external horizontal synchronization (HSYNC) signal, a source of a clock associated with the external HSYNC signal from being generated via a phased lock loop (PLL) clock to being generated via a resistor-capacitor (RC) oscillator clock. An HSYNC signal may refer to a signal that synchronizes a start of a horizontal picture scan line in a display panel with a picture source. The signal may include a pulsed signal. An external HSYNC signal may be a signal that is not produced by a display processor, or a DDIC. The external HSYNC signal may also be referred to as an ESYNC signal. The display processor, or DDIC, may use the ESYNC signal for synchronizing the start of a horizontal picture scan line in a display panel with a picture source. The ESYNC signal may be transmitted continuously, for example transmitted without a break in between transmissions, or transmitted via a plurality of transmissions where the period in between any two of the plurality of consecutive transmissions is constant. An ESYNC signal that is transmitted continuously may also be referred to as a continuous ESYNC signal. An EM pulse may include a signal to control light emission. In some aspects, a frame rate of graphical content may be divisible by the rate of a set of EM pulses. As such, a variation of a frame rate may be discrete. In an example, an EM pulse may run at a slower rate than a rate of a line. A period of an EM signal associated with the EM pulse may be a multiple of a period of an HSYNC signal. A period of a frame may be in multiple periods of the EM signal. A PLL clock may be a clock that maintains its frequency based on a reference signal. For example, the PLL clock may periodically adjust its frequency based on a reference signal. In contrast, an RC clock uses a combination of resistors and capacitors to maintain the frequency of a timing signal, for example by leveraging the amount of time a capacitor discharges. An RC clock may be less accurate than a PLL clock. For example, an RC clock may run at a slower speed than a PLL clock. Vis-à-vis switching the source of the clock from being generated via the PLL clock to being generated via the RC oscillator clock, the apparatus may conserve power. With more particularity, the apparatus may conserve power while keeping track of video timing and continuously transferring the external HSYNC signal to a display driver integrated circuit (DDIC) during a static screen. A DDIC may be an integrated circuit chip that controls switching and display methodologies of a display panel. In an example, a display panel may be a low-temperature polycrystalline oxide (LTPO) display panel.

In some aspects, a clock may be configured to generate the external HSYNC signal. The apparatus may transmit the continuous external HSYNC signal to a DDIC. For example, the apparatus may transmit the continuous external HSYNC signal to the DDIC via a display serial interface (DSI) (e.g., a mobile industry processor interface (MIPI) DSI). In some aspects, the apparatus may associate the switch of the source of the clock with a power transmission associated with a frame rate variation. For example, the apparatus may be configured to transition from a first power mode to a second power mode based on a change of a frame rate. The apparatus may be configured to trigger both the transition to the second power mode and the switch of the source of the clock based on the frame rate variation. In some aspects, the display panel may support variable refresh rates. The apparatus may be configured to transition from a first power mode to a second power mode based on a change of a refresh rate. The apparatus may be configured to trigger both the transition to the second power mode and the switch of the source of the clock based on the refresh rate variation. A display panel may be associated with a refresh rate, which is the number of times per time period that the display updates the image on the screen. For example, a display panel that refreshes the image 60 times per second may be referred to as a display panel having a refresh rate of 60 hertz (Hz). A display panel may change its refresh rate within a time period. The change of a refresh rate at a display is referred to as a refresh rate variation. A frame rate refer to the number of frames per time period that a graphics processor produces frames for display at a display panel. For example, a graphics processor may be configured to produce 30 frames per second (fps) or 120 fps. In some aspects, a frame rate of graphical content may be divisible by the rate of a set of EM pulses. As such, a variation of a frame rate may be discrete. A graphics processor may change its frame rate within a time period. The change of a frame rate at a graphics processor may be referred to as a frame rate variation.

In some aspects, the apparatus may inactivate, based on the switch of the source of the clock from being generated via the PLL clock to being generated via the RC oscillator clock, a set of resources associated with the PLL clock. The set of resources associated with the PLL clock may include at least one of a power source of the PLL clock, a reference crystal clock associated with the PLL clock, or a circuit for reference current and reference voltage generation associated with the PLL. The set of resources may be unused when using the RC clock, and may be reactivated in response to switching the source of the clock back to the PLL clock. In some aspects, the apparatus may determine that the AP is to transition from the second power mode to the first power mode based on a second change in the refresh rate of the display panel. In some aspects, the apparatus may switch, based on the determination that the AP is to transition from the second power mode to the first power mode and during the transmission of the continuous external HSYNC signal, the source of the clock from being generated via the RC oscillator clock to being generated via the PLL clock. In some aspects, the apparatus may activate, based on the switch of the source of the clock from being generated via the RC oscillator clock to being generated via the PLL oscillator clock, the set of resources associated with the PLL clock. In some aspects, the apparatus may associate the continuous HSYNC signal with a set of emission pulses, or EM pulses. Each pulse in the set of EM pulses may correspond to multiple lines of the display panel. In some aspects, the apparatus may transition the AP from the first power mode to the second power mode after switching the source of the clock. The first power mode may be associated with a first power consumption. The second power mode may be associated with a second power consumption that is less than the first power consumption. The PLL clock may be associated with a first power consumption and a first clock accuracy. The RC oscillator clock may be associated with a second power consumption and a second clock accuracy. The first power consumption may be greater than the second power consumption, and the first clock accuracy may be greater than the second clock accuracy. In some aspects, the apparatus may receive, from software, an indication of the change in the refresh rate of the display panel. The software may monitor triggers that cause a display processor to change the power mode of an AP. The determination that the AP is to transition from the first power mode to the second power mode may be based on the indication. In some aspects, the apparatus may output an indication of the switch of the source of the clock. Outputting the indication of the switch may trigger the source of the clock to switch from the PLL clock to the RC oscillator clock.

In some aspects, a DDIC may generate an EM pulse for low-temperature polycrystalline oxide (LTPO) panels by using a display interface signal for display serial interface (DSI) video hybrid mode operations. The display interface signal may also be referred to as an external HYNC (ESYNC) pulse. On the ESYNC signal, the DDIC may generate a pulse for every line. A display processor may be configured to maintain a constant EM pulse rate. The display processor may be configured to evenly spread the number of pulses within a frame. In some aspects, an ESYNC hybrid mode may be implemented via a hardware (HW) mechanism configured to switch the source of ESYNC generation without stopping the ESYNC output to the DDIC. Such a HW mechanism may be referred to as a mode switcher. The display processor may generate an ESYNC pulse using an accurate clock source during active frame transfers and a power efficient source (e.g., an RC oscillator) during static display. While the RC oscillator may be less accurate, the reduced accuracy may be acceptable at low framerates.

Particular aspects of the subject matter described in this disclosure can be implemented to realize one or more of the following potential advantages. In some examples, by transitioning the source of an ESYNC pulse without stopping the ESYNC output to a DDIC, the described techniques can be used to generate an ESYNC signal using an accurate clock source during active frame transfers and a power-efficient source during a static display.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

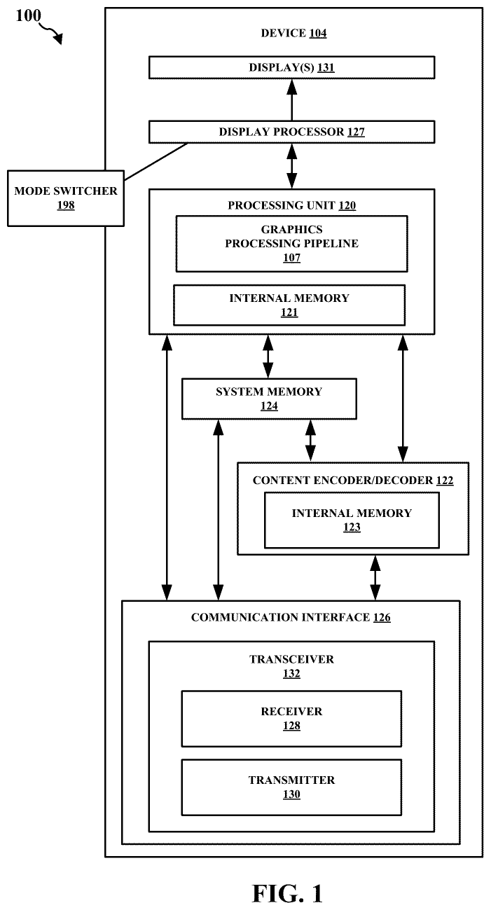

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the display processor 127 may include a mode switcher 198 configured to determine that an application processor (AP) is to transition from a first power mode to a second power mode based on a change in a refresh rate of a display panel; and switch, based on the determination and during a transmission of a continuous external horizontal synchronization (HSYNC) signal, a source of a clock associated with the external HSYNC signal from being generated via a phased lock loop (PLL) clock to being generated via a resistor-capacitor (RC) oscillator clock. In one aspect, the mode switcher 198 may switch from a main external HSYNC generator that uses a PLL clock to a backup external HSYNC generator that uses an RC oscillator clock. Although the following description may be focused on display processing, the concepts described herein may be applicable to other similar processing techniques. Furthermore, although the following description may be focused on phased lock loop (PLL) clock sources and resistor-capacitor (RC) oscillator clock sources, the concepts described herein may also be applicable to other types of clock sources as well. For instance, the concepts described herein may be applicable to a first clock source and a second clock source, where the first clock source is associated with a first power consumption, a first frequency, and a first accuracy and the second clock source is associated with a second power consumption, a second frequency, and a second accuracy, where the first power consumption is greater than the second power consumption, where the first frequency is greater than the second frequency, and where the first accuracy is greater than the second accuracy. In one aspect, an RC oscillator clock frequency may be lower than a PLL clock frequency. In one aspect, an RC oscillator clock may be used to drive a backup external HSYNC generator and a PLL clock may be used to drive a main external HSYNC generator and a display serial interface (DSI). A DSI may be utilize a relatively high clock speed to support a maximum refresh rate of a display panel. Thus, a PLL clock may run at a higher clock speed compared to a clock speed of an RC oscillator clock.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

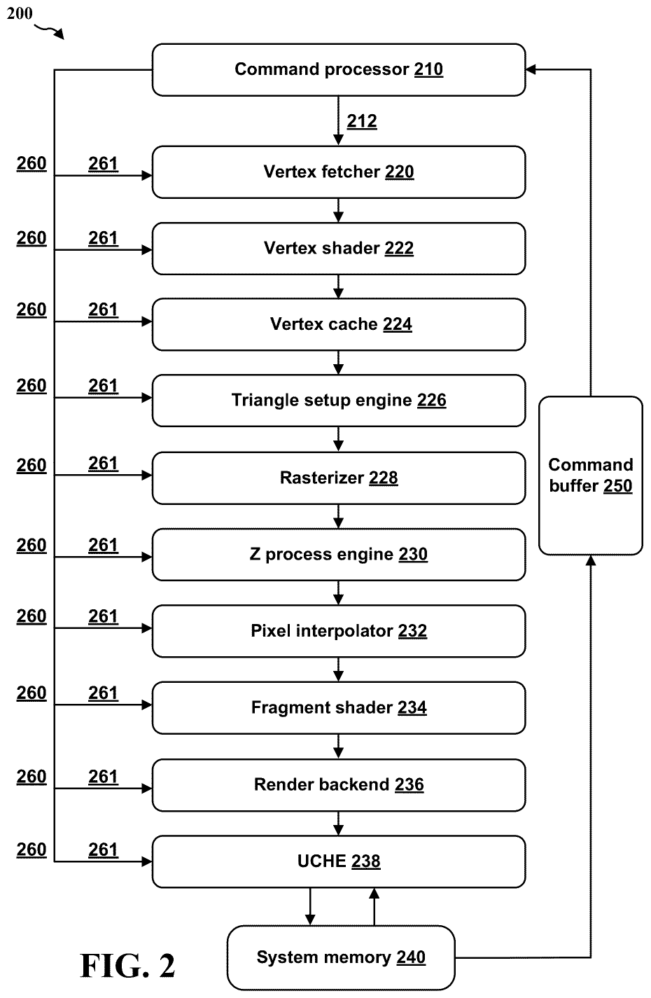

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUS, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

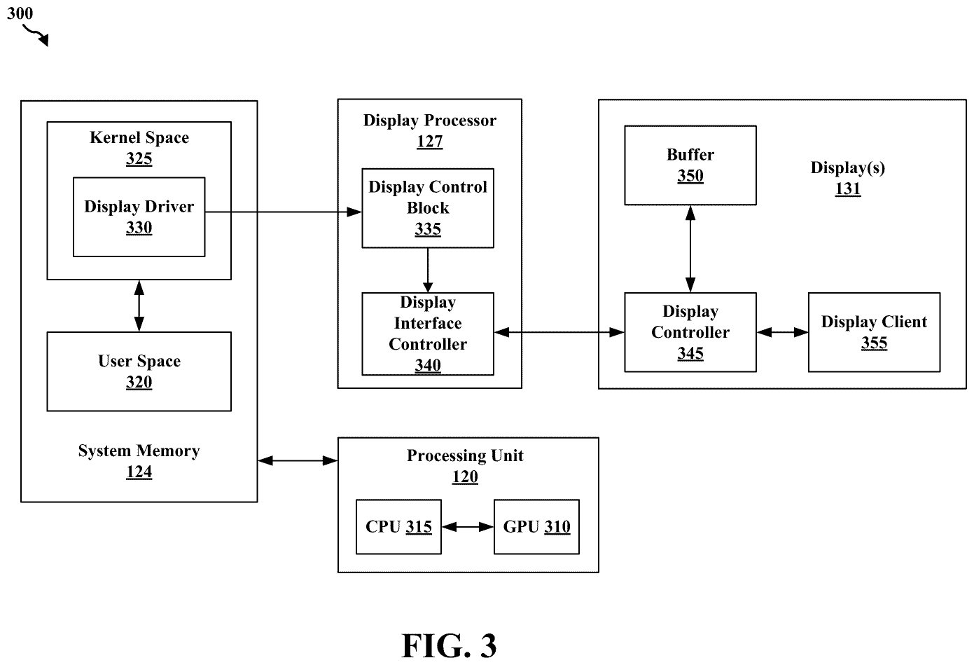

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface controller 340. The display processor 127 may be configured to manipulate functions of the display(s) 131 (e.g., based on an input received from the display driver 330). The display control block 335 may be further configured to output image frames to the display(s) 131 via the display interface controller 340. In some examples, the display control block 335 may additionally or alternatively perform post-processing of image data provided based on execution of the system memory 124 by the processing unit 120.

The display interface controller 340 may be configured to cause the display(s) 131 to display image frames. The display interface controller 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface controller 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface controller 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

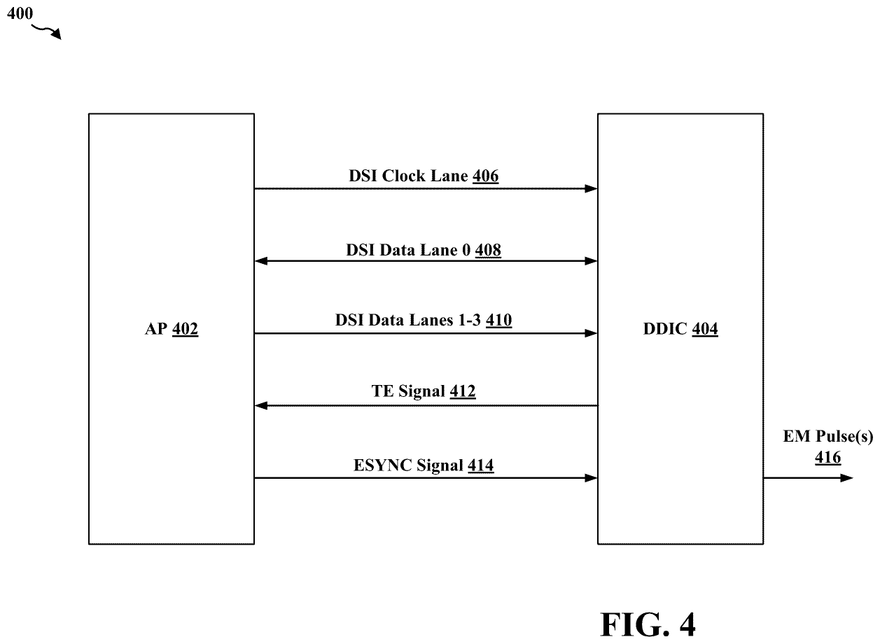

FIG. 4 is a diagram 400 illustrating an example of a display interface between an application processor (AP) 402 and a display driver integrated circuit (DDIC) 404 in accordance with one or more techniques of this disclosure. The AP 402 and the DDIC 404 may be included in the device 104. As used here, an AP may refer to a system composed of different types of processors for different types of applications. A display processor may be part of an application processor, where the display processor may act as a host processor that is responsible for transmitting display frames to a display device. An application processor may also be referred to as a host processor. As used herein, a DDIC may refer to an integrated circuit chip that controls switching and display methodologies of a display panel. In an example, a display panel (e.g., the display(s) 131) may be a low-temperature polycrystalline oxide (LTPO) display panel. An LTPO display panel may refer to a display panel that uses LTPO backplane technologies that enable the display panel to operate at variable refresh rates. A refresh rate may refer to a rate at which a display (i.e., a display panel) is updated. In an example, at a refresh rate of 120 Hz, a display panel may be updated 120 times per second. In an example, an LTPO display panel may operate at a refresh rate ranging from 1 Hz to 120 Hz, such as 1 Hz, 30 Hz, 60 Hz, 90 Hz, or 120 Hz. In contrast, other types of display panels may be able to operate at a set number of refresh rates (e.g., 60 Hz or 120 Hz). As refresh rate characteristics may vary based on applications (e.g., web browsing, gaming, video, etc.), a display panel with a wider range of variable refresh capabilities may be associated with efficient power consumption compared to power consumptions of other types of display panels that support a fixed or smaller range of refresh rates. For instance, if a display panel (e.g., an LTPO display panel) is to display a static image, the display panel may switch to a lowest (e.g., 1 Hz) refresh rate, which may reduce power consumption of the display panel. When the display panel is to display moving images (e.g., as part of a gaming experience), the panel may switch to a highest (e.g., 120 Hz) refresh rate, which may improve a user experience.

The AP 402 and the DDIC 404 may communicate via a display serial interface (DSI). DSI may refer to a specification promulgated by the Mobile Industry Processor Interface (MIPI) Alliance. DSI may define a serial bus and a communication protocol between a host (e.g., the AP 402) and a destination (e.g., the DDIC 404). The AP 402 may communicate clock information to the DDIC 404 via a DSI clock lane 406. The DSI clock lane 406 may be carried on two wires. The AP 402 and the DDIC 404 may communicate data via a zeroth DSI data lane 408. The zeroth DSI data lane may be capable of bi-directional communication of data. For instance, (1) the AP 402 may transmit data to the DDIC 404 via the zeroth DSI data lane 408 and the DDIC 404 may receive the data from the AP 402 via the zeroth DSI data lane 408 and (2) the DDIC 404 may transmit data to the AP 402 via the zeroth DSI data lane 408 and the AP 402 may receive the data from the DDIC 404 via the zeroth DSI data lane 408. The AP 402 may also communicate data to the DDIC 404 via a first DSI data lane, a second DSI data lane, and a third DSI data lane (referred to hereafter as DSI data lanes 1-3 410). The DDIC 404 may transmit a tearing effect (TE) signal 412 to the AP 402. The TE signal 412 may be a signal that is configured to mitigate or prevent image tearing when images are refreshed on a display panel.

The AP 402 may be configured to transmit an external horizontal synchronization signal (HSYNC) signal to the DDIC 404. The external HSYNC signal may be referred to as an ESYNC signal 414. The ESYNC signal 414 may be transmitted continuously. The DDIC 404 may generate emission (EM) pulse(s) 416 for a display panel (e.g., an LTPO display panel) based on the ESYNC signal 414. An EM pulse may refer to a signal to control light emission. In an example, upon receiving the ESYNC signal 414, the DDIC 404 may generate the EM pulse(s) 416 for every line of the display panel. A rate of the EM pulse(s) 416 (i.e., an EM pulse rate) may be kept constant (i.e., fixed) and a number of the EM pulse(s) 416 may be spread evenly within a frame (i.e., the AP 402 may vary a frame period by steps of a cycle (i.e., an EM cycle) of the EM pulse(s) 416). In one aspect, a frame rate of graphical content may be divisible by the rate of the EM pulse(s) 416. As such, a variation of a frame rate may be discrete. In an example, an EM pulse may run at a slower rate than a rate of a line. A period of an EM signal associated with the EM pulse may be a multiple of a period of an HSYNC signal. A period of a frame may be in multiple periods of the EM signal.

As indicated above, some display panels (e.g., an LTPO display panel) may support a wide range of frame variation. The wide range of frame variation may be supported by extending a vertical front porch (VFP) of a frame as a frame rate is adjusted to be lower (i.e., slower) than a maximum refresh rate of a display panel. A VFP may refer to a number of lines (e.g., HSYNC pulses) between a last data line of a frame and a next vertical synchronization (VSYNC) pulse. In an example, for a static screen (i.e., a screen displaying a static image), a frame rate of a display panel may drop to a minimum refresh rate, such as 1 Hz).

Aspects presented herein may pertain to a mechanism for (1) allowing the AP 402 to transition to a low power state by disabling unused resources between frames at a low update rate, (2) keeping track of video timing, and (3) continuously transferring the ESYNC signal 414 to the DDIC 404 during a static screen. With more particularity, a hardware mechanism, referred to as “ESYNC hybrid mode,” is described herein. ESYNC hybrid mode may switch a source of an ESYNC signal generation without stopping an output of the ESYNC signal 414 to the DDIC 404. As will be described in greater detail below, in ESYNC hybrid mode, the ESYNC signal 414 may be generated using a relatively accurate clock source during active frame transfers and the ESYNC signal 414 may be generated using a relatively power efficient clock source during the display of static frames.

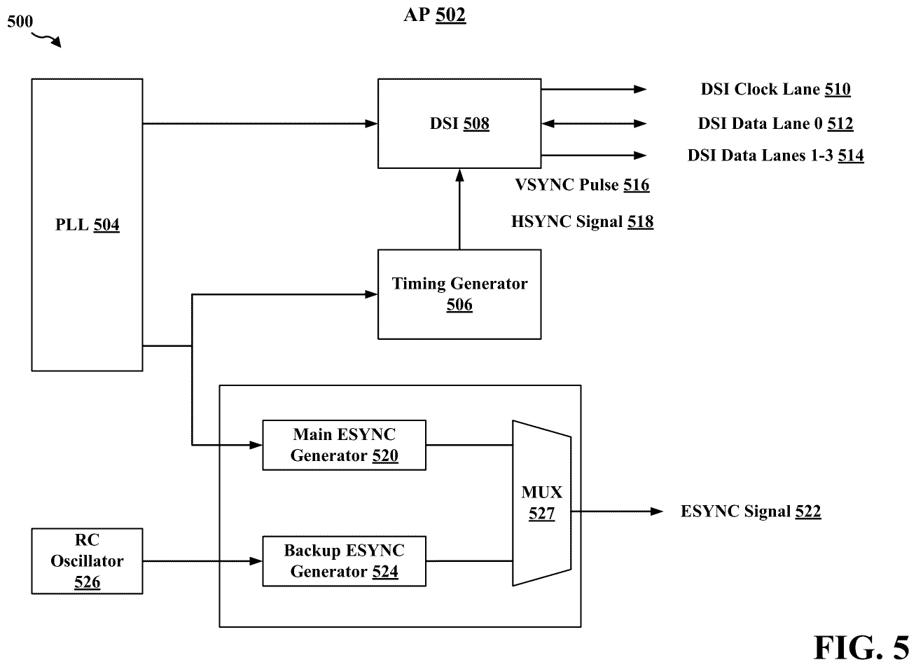

FIG. 5 is a diagram 500 illustrating an example of a display interface controller in an AP 502 in accordance with one or more techniques of this disclosure. In an example, the AP 502 may be or include the AP 402. The AP 502 may be included in the device 104.

The AP 502 may include or may be associated with a PLL 504. The PLL 504 may be a hardware PLL. The AP 502 may also include or be associated with a timing generator 506. The PLL 504 may be a source of a clock for the timing generator 506. The timing generator 506 may generate timing signals to control a display panel (e.g., the display(s) 131) based on a clock from the PLL 504. In an example, the PLL 504 may be a source of clock(s) for a DSI 508 (i.e., a DSI controller). With more particularity, the clock (or the information associated with the clock) may be transmitted via a DSI clock lane 510. High speed data may be transmitted to/from the AP 502 to the DDIC 404 via a zeroth DSI data lane 512, that is, the zeroth DSI data lane 512 may be bidirectional in a low power mode. Data may be transmitted from the AP 502 via DSI data lanes 1-3 514. In one aspect, the timing generator 506 may be utilized to generate a vertical synchronization (VSYNC) pulse 516. A VSYNC pulse may refer to a pulse that synchronizes a start of a frame in a display panel with a picture source. The timing generator 506 may also be utilized to generate a horizontal synchronization (HSYNC) pulse 518. An HSYNC pulse may refer to a pulse that synchronizes a start of a horizontal picture scan line in a display panel with a picture source.

The AP 502 may include or be associated with a main ESYNC generator 520 that is configured to generate an ESYNC signal 522 during an active frame transfer. In an example, the main ESYNC generator 520 may generate the ESYNC signal 522 when a display panel is operating at a relatively high refresh rate (e.g., 120 Hz). The ESYNC signal 522 may be or include the ESYNC signal 414. The main ESYNC generator 520 may generate the ESYNC signal 522 based on a clock driven (i.e., generated) by the PLL 504. A clock may also be referred to as a clock signal. A clock (i.e., a clock signal) may be an electronic logic signal (voltage or current) which oscillates between a high state and a low state at a constant frequency and which may be used to synchronize actions of digital circuits. In an example, a clock signal may be a square wave with a 50% duty cycle. The ESYNC signal 522 may be transmitted to a DDIC (e.g., the DDIC 404) and the DDIC may generate an EM pulse (e.g., the EM pulse(s) 416) based on ESYNC signal 522 as described above.

In an example, the AP 502 may transition from a first power mode (e.g., a high power mode) to a second power mode (e.g., a second power mode). In an example, the first power mode may be associated with a first power consumption and the second power mode may be associated with a second power consumption that is less than the first power consumption. In an example, the AP 502 may transition from the first power mode to the second power mode between updates at a low frame rate. In one aspect, the AP 502 may transition from the first power mode to the second power mode upon receiving an indication from software executed by a device (e.g., the device 104). Before the AP 502 transitions from the first power mode to the second power mode, the AP 502 may seamlessly transition generation of the ESYNC signal 522 from the main ESYNC generator 520 to a backup ESYNC generator 524 included in or associated with the AP 502. After the transition, the backup ESYNC generator 524 may generate the ESYNC signal 522. The backup ESYNC generator 524 may generate the ESYNC signal 522 based on a clock driven (i.e., generated) by a resistor-capacitor (RC) oscillator 526 included in or associated with the AP 502. An RC oscillator may refer to a linear oscillator circuit which uses an RC network (i.e., a combination of resistors and capacitors) for a frequency selection. The RC oscillator 526 may be more power efficient than the PLL 504; however, the PLL 504 may be more accurate than the RC oscillator 526. The lower accuracy associated with the RC oscillator 526 may not have a noticeable impact on performance at low frames (e.g., when a static frame is displayed). In an example, the PLL 504 may be associated with a first clock accuracy, a first frequency, and a first power consumption and the RC oscillator 526 may be associated with a second clock accuracy, a second frequency, and a second power consumption, where the first clock accuracy is greater than the second clock accuracy, the first frequency is higher than the second frequency, and the first power consumption is greater than the second power consumption. As used herein, the term “clock accuracy” may refer to how close a clock is to a true clock value. A clock accuracy may be associated with a fluctuation of a periodicity of a clock signal. As used herein, the term “power consumption” may refer to an amount of power consumed. In an example, a static frame may be displayed on a display panel (e.g., the display(s) 131) when the backup ESYNC generator 524 generates the ESYNC signal 522 and when the DSI 508 is idle.

After the AP 502 transitions from the main ESYNC generator 520 to the backup ESYNC generator 524, the AP 502 may inactivate the PLL 504 and/or resources associated with the PLL 504 in order to conserve power during an idle period (e.g., during a period at which a static frame is displayed on a display panel). In an example, the resources associated with the PLL 504 may be or include a power source of the PLL 504, a reference crystal clock associated with the PLL 504, and/or a circuit for reference current and reference voltage generation associated with the PLL 504. A reference crystal clock may refer to a crystal oscillator in an electronic oscillator circuit that uses a piezoelectric crystal as a frequency-selective element. The reference crystal clock may be used to provide a stable clock signal.

To resume active frame transfer (e.g., when a new, non-static frame is to be displayed on a display panel), the AP 502 may activate (i.e., “wake up”) the inactivated resources associated with the PLL 504 and the AP 502 may seamlessly transition generation of the ESYNC signal 522 from the backup ESYNC generator 524 to the main ESYNC generator 520. For instance, the AP 502 may wake up the resources associated with the PLL 504 and the clock may begin to again be driven by the PLL 504. In an example, the AP 502 may receive an indication from software, and the AP 502 may transition generation of the ESYNC signal 522 from the backup ESYNC generator 524 to the main ESYNC generator 520 based on the indication. The new, non-static frame may re-align to an EM pulse boundary based on timing information from the main ESYNC generator 520.

In one aspect, the AP 502 may include or may be associated with a multiplexor (MUX) 527. A MUX may refer to a device that selects between several analog or digital input signals and that forwards a selected input to a single output line. The MUX 527 may select the main ESYNC generator 520 (which uses a clock driven by the PLL 504) or the backup ESYNC generator 524 (which uses a clock driven by the RC oscillator 526) based on various criteria, such as an indication from software.

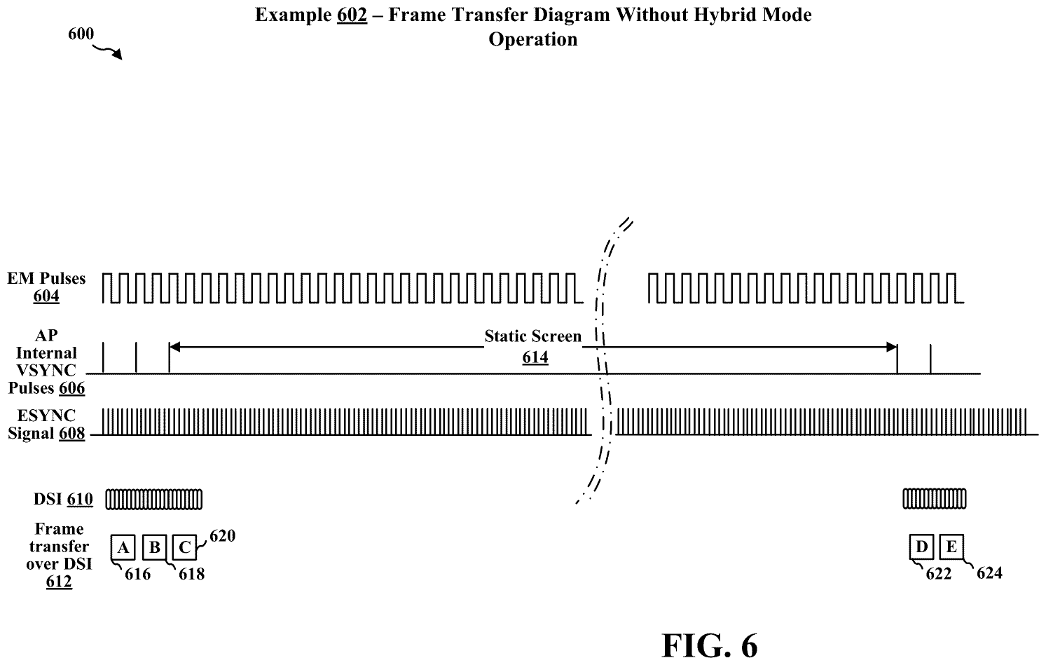

FIG. 6 is a diagram 600 illustrating an example 602 of a frame transfer diagram without hybrid mode operation in accordance with one or more techniques of this disclosure. The frame transfer diagram depicts EM pulses 604, AP internal VSYNC pulses 606, an ESYNC signal 608, information transmitted over a DSI 610, and a frame transfer over DSI 612. As shown in the example 602, the EM pulses 604 may be square waves. As shown in the example 602, AP internal VSYNC pulses 606 (i.e., the VSYNC pulse 516) may not be generated during a static screen 614. The ESYNC signal 608 may be continuously generated. In an example, the frames transferred over the DSI 612 may include frame A 616, frame B 618, frame C 620, frame D 622, and frame E 624. In an example, frame C 620 may be a statically displayed frame and frame A 616, frame B 618, frame D 622, and frame E 624 may be non-statically displayed frames.

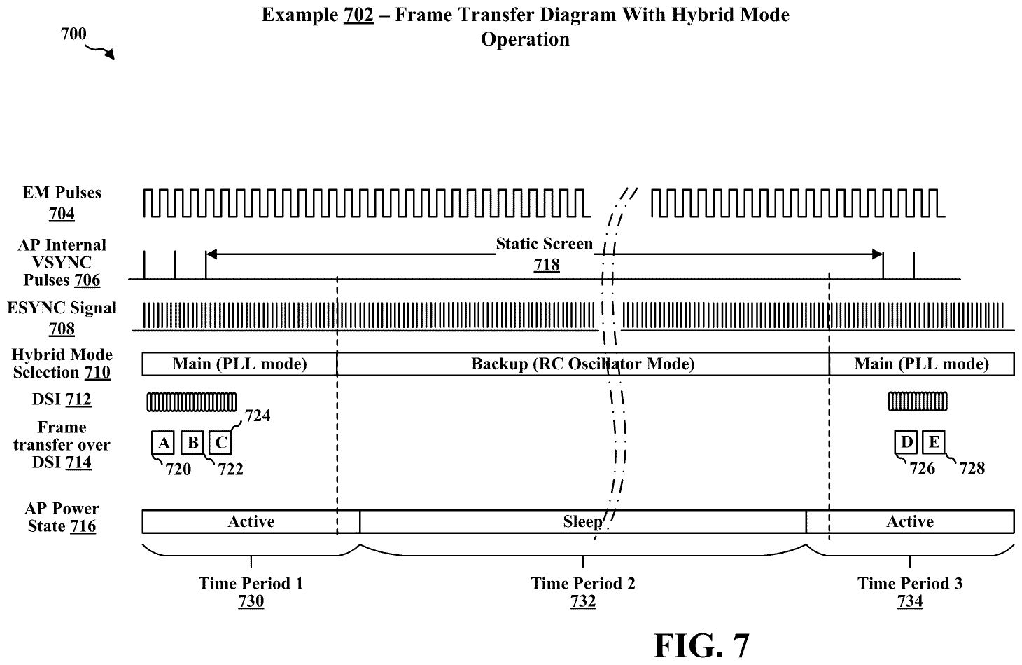

FIG. 7 is a diagram 700 illustrating an example 702 of a frame transfer diagram with hybrid mode operation in accordance with one or more techniques of this disclosure. The frame transfer diagram depicts EM pulses 704, AP internal VSYNC pulses 706, an ESYNC signal 708, a hybrid mode selection 710, a DSI 712, a frame transfer over DSI 714, and an AP power state 716. As shown in the example 702, the EM pulses 704 may be square waves. A shown in the example 702, AP internal VSYNC pulses 706 (i.e., the VSYNC pulse 516) may not be generated during a static screen 718. The ESYNC signal 708 may be continuously generated. In an example, the frames transferred over the DSI 712 may include frame A 720, frame B 722, frame C 724, frame D 726, and frame E 728. In an example, frame C 724 may be a statically displayed frame and frame A 720, frame B 722, frame D 726, and frame E 728 may be non-statically displayed frames.

As depicted by the hybrid mode selection 710, an AP (e.g., the AP 402, the AP 502) may utilize a main ESYNC generator (e.g., the main ESYNC generator 520) in PLL mode during a first time period 730, that is, the main ESYNC generator may generate the ESYNC signal 708 using a clock generated by a PLL (e.g., the PLL 504). The AP power state 716 may be active during the first time period 730. As frame C 724 is a statically displayed frame, during a second time period 732 occurring after the first time period 730, the AP may utilize a backup ESYNC generator (e.g., the backup ESYNC generator 524) in RC oscillator mode, that is, the backup ESYNC generator may generate the ESYNC signal 708 using a clock generated by an RC oscillator (e.g., RC oscillator 526). The AP power state 716 may be in a sleep state during the second time period 732. As frame D 726 is a non-statically displayed frame, during a third time period 734 occurring after the second time period 732, the AP may utilize the main ESYNC generator in PLL mode, that is, the main ESYNC generator may generate the ESYNC signal 708 using a clock generated by the PLL. The AP power state 716 may be active during the third time period 734.

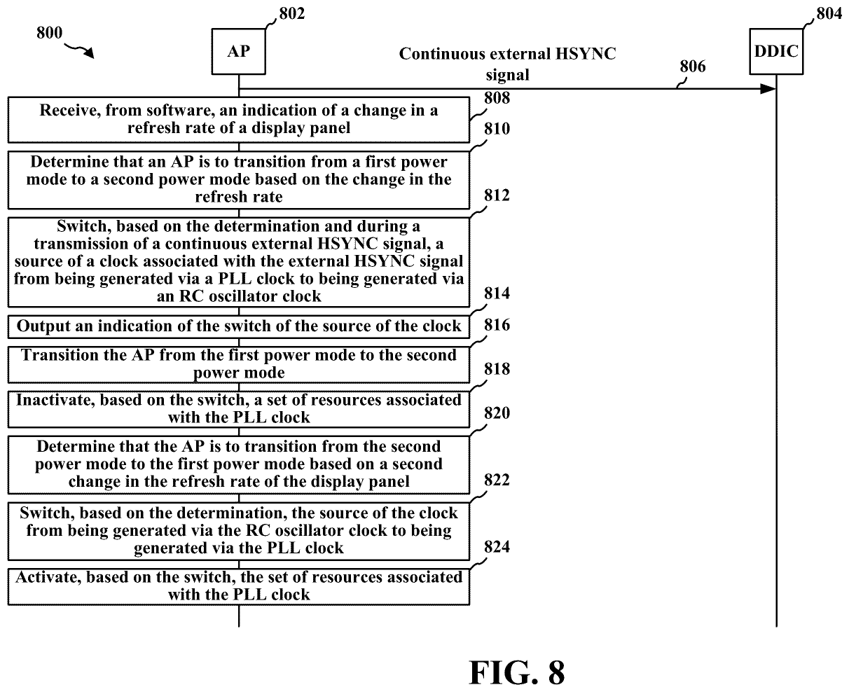

FIG. 8 is a call flow diagram 800 illustrating example communications between an AP 802 and a DDIC 804 in accordance with one or more techniques of this disclosure. In an example, the AP 802 and the DDIC 804 may be included in the device 104. In an example, the AP 802 may be the AP 402 or the AP 502. In an example, the DDIC 804 may be the DDIC 404.

At 810, the AP 802 may determine that an application processor (AP) is to transition from a first power mode to a second power mode based on a change in a refresh rate of a display panel. At 812, the AP 802 may switch, based on the determination and during a transmission of a continuous external horizontal synchronization (HSYNC) signal, a source of a clock associated with the external HSYNC signal from being generated via a phased lock loop (PLL) clock to being generated via a resistor-capacitor (RC) oscillator clock. At 816, the AP 802 may transition the AP from the first power mode to the second power mode.

At 806, the AP 802 may transmit, to a display driver integrated circuit (DDIC) (e.g., the DDIC 804), the continuous external HSYNC signal.

At 818, the AP 802 may inactivate, based on the switch of the source of the clock from being generated via the PLL clock to being generated via the RC oscillator clock, a set of resources associated with the PLL clock.

At 820, the AP 802 may determine that the AP is to transition from the second power mode to the first power mode based on a second change in the refresh rate of the display panel. At 822, the AP 802 may switch, based on the determination that the AP is to transition from the second power mode to the first power mode and during the transmission of the continuous external HSYNC signal, the source of the clock from being generated via the RC oscillator clock to being generated via the PLL clock. At 824, the AP 802 may activate, based on the switch of the source of the clock from being generated via the RC oscillator clock to being generated via the PLL oscillator clock, the set of resources associated with the PLL clock.

At 808, the AP 802 may receive, from software, an indication of the change in the refresh rate of the display panel, where the determination that the AP is to transition from the first power mode to the second power mode is based on the indication. At 814, the AP 802 may output an indication of the switch of the source of the clock.

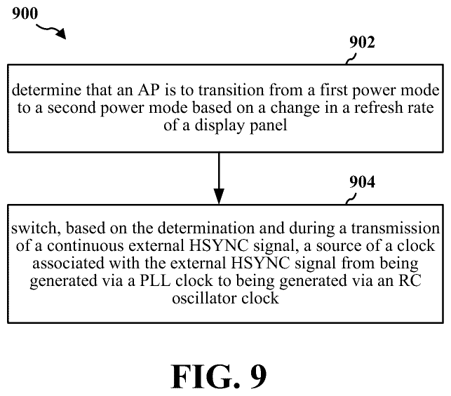

FIG. 9 is a flowchart 900 of an example method of display processing in accordance with one or more techniques of this disclosure. The method may be performed by an apparatus, such as an apparatus for display processing, a display processing unit (DPU) or other display processor, an AP (e.g., the AP 402, the AP 502), the device 104, a wireless communication device, and the like, as used in connection with the aspects of FIGS. 1-8. In an example, the method (including the various aspects detailed below) may be performed by the mode switcher 198.

At 902, the apparatus determines that an application processor (AP) is to transition from a first power mode to a second power mode based on a change in a refresh rate of a display panel. For example, FIG. 8 at 810 shows that the AP 802 may determine that an application processor (AP) (e.g., the AP 802) is to transition from a first power mode to a second power mode based on a change in a refresh rate of a display panel. In an example, the AP 802 may be the AP 402 or the AP 502. In an example, the display panel may be or include the display(s) 131. In an example, 902 may be performed by the mode switcher 198.

At 904, the apparatus switches, based on the determination and during a transmission of a continuous external horizontal synchronization (HSYNC) signal, a source of a clock associated with the external HSYNC signal from being generated via a phased lock loop (PLL) clock to being generated via a resistor-capacitor (RC) oscillator clock. For example, FIG. 8 at 812 shows that the AP 802 may switch, based on the determination at 810 and during a transmission of a continuous external horizontal synchronization (HSYNC) signal, a source of a clock associated with the external HSYNC signal from being generated via a phased lock loop (PLL) clock to being generated via a resistor-capacitor (RC) oscillator clock. In an example, the continuous external HSYNC signal may be or include the ESYNC signal 414 or the ESYNC signal 522. In another example, the continuous external HSYNC signal may be or include the ESYNC signal 708. In an example, the switch be associated with the hybrid mode selection 710 in FIG. 7. In an example, the PLL clock may correspond to the PLL 504 and the RC oscillator clock may correspond to the RC oscillator 526. In an example, the switch may be associated with the second time period 732. In an example, 904 may be performed by the mode switcher 198.

In one aspect, the clock may be configured to generate the external HSYNC signal. For example, the clock may be configured to generate the ESYNC signal 414, the ESYNC signal 522, or the ESYNC signal 708.

In one aspect, the apparatus may transmit, to a display driver integrated circuit (DDIC), the continuous external HSYNC signal. For example, FIG. 8 at 806 shows that the AP 802 may transmit, to a DDIC (e.g., the DDIC 804), the continuous external HSYNC signal.

In one aspect, the switch of the source of the clock may be associated with a power mode transition associated with a frame rate variation. For example, the switch of the source of the clock at 812 may be associated with a power mode transition associated with a frame rate variation. In an example, frame rate variation may be associated with frames referenced in FIG. 7.

In one aspect, the change in the refresh rate may be associated with a range of refresh rates supported by the display panel and update characteristics of display content. For example, the refresh rate of a panel with variable refresh capability may vary during web browsing, gaming, video playing, etc.

In one aspect, the apparatus may inactivate, based on the switch of the source of the clock from being generated via the PLL clock to being generated via the RC oscillator clock, a set of resources associated with the PLL clock. For example, FIG. 8 at 818 shows that the AP 802 may inactivate, based on the switch of the source of the clock from being generated via the PLL clock to being generated via the RC oscillator clock, a set of resources associated with the PLL clock.

In one aspect, the set of resources associated with the PLL clock may include at least one of a power source of the PLL clock, a reference crystal clock associated with the PLL clock, or a circuit for reference current and reference voltage generation associated with the PLL. For example, the set of resources at 818 may include at least one of a power source of the PLL clock, a reference crystal clock associated with the PLL clock, or a circuit for reference current and reference voltage generation associated with the PLL.

In one aspect, the apparatus may determine that the AP is to transition from the second power mode to the first power mode based on a second change in the refresh rate of the display panel. For example, FIG. 8 at 820 shows that the AP 802 may determine that the AP is to transition from the second power mode to the first power mode based on a second change in the refresh rate of the display panel.

In one aspect, the apparatus may switch, based on the determination that the AP is to transition from the second power mode to the first power mode and during the transmission of the continuous external HSYNC signal, the source of the clock from being generated via the RC oscillator clock to being generated via the PLL clock. For example, FIG. 8 at 822 shows that the AP 802 may switch, based on the determination that the AP is to transition from the second power mode to the first power mode and during the transmission of the continuous external HSYNC signal, the source of the clock from being generated via the RC oscillator clock to being generated via the PLL clock. In an example, the aforementioned aspect may correspond to the third time period 734.

In one aspect, the apparatus may activate, based on the switch of the source of the clock from being generated via the RC oscillator clock to being generated via the PLL oscillator clock, the set of resources associated with the PLL clock. For example, FIG. 8 at 824 shows that the AP 802 may activate, based on the switch of the source of the clock from being generated via the RC oscillator clock to being generated via the PLL oscillator clock, the set of resources associated with the PLL clock.

In one aspect, the continuous external HSYNC signal may be associated with a set of emission pulses, and where each pulse in the set of emission pulses may correspond to multiple lines of the display panel. For example, the set of emission pulses may be or include the EM pulse(s) 416 or the EM pulses 704, and each pulse in the set of emission pulses may correspond to multiple lines of display(s) 131. For example, where the set of emission pulses are generated at the same rate as the rate of a line of a display, each pulse in the set of emission pulses may be associated with a single line of the display(s) 131. In other words, a pulse of the EM pulse(s) 416 or the EM pulses 704 may be used to generate a single line at the display(s) 131. Where the set of emission pulses are generated at a slower rate than a rate of a line, each pulse in the set of emission pulses may be associated with a plurality of lines of the display(s) 131. In other words, a pulse of the EM pulse(s) 416 or the EM pulses 704 may be used to generate a plurality of lines at the display(s) 131.

In one aspect, the apparatus may transition the AP from the first power mode to the second power mode. For example, FIG. 8 at 816 shows that the AP 802 may transition the AP from the first power mode to the second power mode.

In one aspect, the first power mode may be associated with a first power consumption and the second power mode may be associated with a second power consumption that is less than the first power consumption. For example, the first power mode at 810 may be associated with a first power consumption and the second power mode at 810 may be associated with a second power consumption that is less than the first power consumption.

In one aspect, the PLL clock may be associated with a first power consumption, a first frequency, and a first clock accuracy, where the RC oscillator clock may be associated with a second power consumption, a second frequency, and a second clock accuracy, where the first power consumption may be greater than the second power consumption, where the first frequency may be greater than the second frequency, and where the first clock accuracy may be greater than the second clock accuracy. For example, the PLL clock at 812 may be associated with a first power consumption, a first frequency, and a first clock accuracy, where the RC oscillator clock at 812 may be associated with a second power consumption, a second frequency, and a second clock accuracy, where the first power consumption may be greater than the second power consumption, where the first frequency may be greater than the second frequency, and where the first clock accuracy may be greater than the second clock accuracy.

In one aspect, the apparatus may receive, from software, an indication of the change in the refresh rate of the display panel, where the determination that the AP is to transition from the first power mode to the second power mode may be based on the indication. For example, FIG. 8 at 808 shows that the AP 802 may receive, from software, an indication of the change in the refresh rate of the display panel, where the determination at 810 that the AP is to transition from the first power mode to the second power mode may be based on the indication.

In one aspect, the apparatus may output an indication of the switch of the source of the clock. For example, FIG. 8 at 814 shows that the AP 802 may output an indication of the switch of the source of the clock.

In one aspect, outputting the indication of the switch of the source of the clock may include: transmitting the indication of the switch of the source of the clock; or storing the indication of the switch of the source of the clock. For example, outputting the indication of the switch of the source of the clock at 814 may include: transmitting the indication of the switch of the source of the clock; or storing the indication of the switch of the source of the clock.

In configurations, a method or an apparatus for display processing is provided. The apparatus may be a DPU, a display processor, or some other processor that may perform display processing. In aspects, the apparatus may be the display processor 127 within the device 104, or may be some other hardware within the device 104 or another device. The apparatus may include means for determining that an application processor (AP) is to transition from a first power mode to a second power mode based on a change in a refresh rate of a display panel. The apparatus may further include means for switching, based on the determination and during a transmission of a continuous external horizontal synchronization (HSYNC) signal, a source of a clock associated with the external HSYNC signal from being generated via a phased lock loop (PLL) clock to being generated via a resistor-capacitor (RC) oscillator clock. The apparatus may further include means for transmitting, to a display driver integrated circuit (DDIC), the continuous external HSYNC signal. The apparatus may further include means for inactivating, based on the switch of the source of the clock from being generated via the PLL clock to being generated via the RC oscillator clock, a set of resources associated with the PLL clock. The apparatus may further include means for determining that the AP is to transition from the second power mode to the first power mode based on a second change in the refresh rate of the display panel. The apparatus may further include means for switching, based on the determination that the AP is to transition from the second power mode to the first power mode and during the transmission of the continuous external HSYNC signal, the source of the clock from being generated via the RC oscillator clock to being generated via the PLL clock. The apparatus may further include means for activating, based on the switch of the source of the clock from being generated via the RC oscillator clock to being generated via the PLL oscillator clock, the set of resources associated with the PLL clock. The apparatus may further include means for transitioning the AP from the first power mode to the second power mode. The apparatus may further include means for receiving, from software, an indication of the change in the refresh rate of the display panel, where the determination that the AP is to transition from the first power mode to the second power mode is based on the indication. The apparatus may further include means for outputting an indication of the switch of the source of the clock.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of display processing, including: determining that an application processor (AP) is to transition from a first power mode to a second power mode based on a change in a refresh rate of a display panel; and switching, based on the determination and during a transmission of a continuous external horizontal synchronization (HSYNC) signal, a source of a clock associated with the external HSYNC signal from being generated via a phased lock loop (PLL) clock to being generated via a resistor-capacitor (RC) oscillator clock.

Aspect 2 may be combined with aspect 1, wherein the clock is configured to generate the external HSYNC signal.

Aspect 3 may be combined with any of aspects 1-2, further including: transmitting, to a display driver integrated circuit (DDIC), the continuous external HSYNC signal.

Aspect 4 may be combined with any of aspects 1-3, wherein the switch of the source of the clock is associated with a power mode transition associated with a frame rate variation.

Aspect 5 may be combined with any of aspects 1-4, wherein the display panel supports variable refresh rates.

Aspect 6 may be combined with any of aspects 1-5, further including: inactivating, based on the switch of the source of the clock from being generated via the PLL clock to being generated via the RC oscillator clock, a set of resources associated with the PLL clock.

Aspect 7 may be combined with aspect 6, wherein the set of resources associated with the PLL clock includes at least one of a power source of the PLL clock, a reference crystal clock associated with the PLL clock, or a circuit for reference current and reference voltage generation associated with the PLL.

Aspect 8 may be combined with any of aspects 6-7, further including: determining that the AP is to transition from the second power mode to the first power mode based on a second change in the refresh rate of the display panel; and switching, based on the determination that the AP is to transition from the second power mode to the first power mode and during the transmission of the continuous external HSYNC signal, the source of the clock from being generated via the RC oscillator clock to being generated via the PLL clock.

Aspect 9 may be combined with aspect 8, further including: activating, based on the switch of the source of the clock from being generated via the RC oscillator clock to being generated via the PLL oscillator clock, the set of resources associated with the PLL clock.

Aspect 10 may be combined with any of aspects 1-9, wherein the continuous external HSYNC signal is associated with a set of emission pulses, and wherein each pulse in the set of emission pulses corresponds to multiple lines of the display panel.

Aspect 11 may be combined with any of aspects 1-10, further including: transitioning the AP from the first power mode to the second power mode.

Aspect 12 may be combined with any of aspects 1-11, wherein the first power mode is associated with a first power consumption and the second power mode is associated with a second power consumption that is less than the first power consumption.

Aspect 13 may be combined with any of aspects 1-12, wherein the PLL clock is associated with a first power consumption and a first clock accuracy, wherein the RC oscillator clock is associated with a second power consumption and a second clock accuracy, wherein the first power consumption is greater than the second power consumption, and wherein the first clock accuracy is greater than the second clock accuracy.

Aspect 14 may be combined with any of aspects 1-13, further including: receiving, from software, an indication of the change in the refresh rate of the display panel, wherein the determination that the AP is to transition from the first power mode to the second power mode is based on the indication.

Aspect 15 may be combined with any of aspects 1-14, further including: outputting an indication of the switch of the source of the clock.

Aspect 16 may be combined with aspect 15, wherein outputting the indication of the switch of the source of the clock includes: transmitting the indication of the switch of the source of the clock; or storing the indication of the switch of the source of the clock.

Aspect 17 may be combined with aspect 3, wherein transmitting the continuous external HSYNC signal to the DDIC includes: transmitting the continuous external HSYNC signal to the DDIC via a display serial interface (DSI).

Aspect 18 is an apparatus for display processing comprising a processor coupled to a memory and, based on information stored in the memory, the processor is configured to implement a method as in any of aspects 1-17.

Aspect 19 may be combined with aspect 18 and comprises that the apparatus is a wireless communication device comprising at least one of a transceiver or an antenna coupled to the processor.

Aspect 20 is an apparatus for display processing comprising means for implementing a method as in any of aspects 1-17.

Aspect 21 is a computer-readable medium (e.g., a non-transitory computer readable-medium) storing computer executable code, the computer executable code, when executed by a processor, causes the processor to implement a method as in any of aspects 1-17.

Various aspects have been described herein. These and other aspects are within the scope of the following claims.

What is claimed is:

1. An apparatus for display processing, comprising:
a memory; and
a processor coupled to the memory and, based on information stored in the memory, the processor is configured to:
determine that an application processor (AP) is to transition from a first power mode to a second power mode based on a change in a refresh rate of a display panel; and
switch, based on the determination and during a transmission of a continuous external horizontal synchronization (HSYNC) signal, a source of a clock associated with the external HSYNC signal from being generated via a phased lock loop (PLL) clock to being generated via a resistor-capacitor (RC) oscillator clock.

2. The apparatus of claim 1, wherein the clock is configured to generate the external HSYNC signal.

3. The apparatus of claim 1, wherein the processor is further configured to:
transmit, to a display driver integrated circuit (DDIC), the continuous external HSYNC signal.

4. The apparatus of claim 3, wherein, to transmit the continuous external HSYNC signal to the DDIC, the processor is configured to:
transmit the continuous external HSYNC signal to the DDIC via a display serial interface (DSI).

5. The apparatus of claim 1, wherein the switch of the source of the clock is associated with a power mode transition associated with a frame rate variation.

6. The apparatus of claim 1, wherein the display panel supports variable refresh rates.

7. The apparatus of claim 1, wherein the processor is further configured to:
inactivate, based on the switch of the source of the clock from being generated via the PLL clock to being generated via the RC oscillator clock, a set of resources associated with the PLL clock.

8. The apparatus of claim 7, wherein the set of resources associated with the PLL clock includes at least one of a power source of the PLL clock, a reference crystal clock associated with the PLL clock, or a circuit for reference current and reference voltage generation associated with the PLL clock.

9. The apparatus of claim 7, wherein the processor is further configured to:
determine that the AP is to transition from the second power mode to the first power mode based on a second change in the refresh rate of the display panel; and
switch, based on the determination that the AP is to transition from the second power mode to the first power mode and during the transmission of the continuous external HSYNC signal, the source of the clock from being generated via the RC oscillator clock to being generated via the PLL clock.

10. The apparatus of claim 9, wherein the processor is further configured to:
activate, based on the switch of the source of the clock from being generated via the RC oscillator clock to being generated via the PLL oscillator clock, the set of resources associated with the PLL clock.

11. The apparatus of claim 1, wherein the continuous external HSYNC signal is associated with a set of emission pulses, and wherein each pulse in the set of emission pulses corresponds to multiple lines of the display panel.

12. The apparatus of claim 1, wherein the PLL clock is associated with a first power consumption and a first clock accuracy, wherein the RC oscillator clock is associated with a second power consumption and a second clock accuracy, wherein the first power consumption is greater than the second power consumption, and wherein the first clock accuracy is greater than the second clock accuracy.

13. The apparatus of claim 1, wherein the processor is further configured to:
receive, from software, an indication of the change in the refresh rate of the display panel, wherein the determination that the AP is to transition from the first power mode to the second power mode is based on the indication.

14. The apparatus of claim 1, wherein the processor is further configured to:
output an indication of the switch of the source of the clock, wherein to output the indication of the switch of the source of the clock, the processor is configured to:
transmit the indication of the switch of the source of the clock; or
store the indication of the switch of the source of the clock.

15. The apparatus of claim 1, wherein the apparatus comprises a wireless communication device comprising at least one of a transceiver or an antenna coupled to the processor.

16. A method of display processing, comprising:
determining that an application processor (AP) is to transition from a first power mode to a second power mode based on a change in a refresh rate of a display panel; and
switching, based on the determination and during a transmission of a continuous external horizontal synchronization (HSYNC) signal, a source of a clock associated with the external HSYNC signal from being generated via a phased lock loop (PLL) clock to being generated via a resistor-capacitor (RC) oscillator clock.

17. The method of claim 16, further comprising:
inactivating, based on the switch of the source of the clock from being generated via the PLL clock to being generated via the RC oscillator clock, a set of resources associated with the PLL clock.

18. The method of claim 17, further comprising:
determining that the AP is to transition from the second power mode to the first power mode based on a second change in the refresh rate of the display panel; and
switching, based on the determination that the AP is to transition from the second power mode to the first power mode and during the transmission of the continuous external HSYNC signal, the source of the clock from being generated via the RC oscillator clock to being generated via the PLL clock.

19. The method of claim 18, further comprising:
activating, based on the switch of the source of the clock from being generated via the RC oscillator clock to being generated via the PLL oscillator clock, the set of resources associated with the PLL clock.

20. A computer-readable medium storing computer executable code, the computer executable code, when executed by a processor, causes the processor to:
determine that an application processor (AP) is to transition from a first power mode to a second power mode based on a change in a refresh rate of a display panel; and
switch, based on the determination and during a transmission of a continuous external horizontal synchronization (HSYNC) signal, a source of a clock associated with the external HSYNC signal from being generated via a phased lock loop (PLL) clock to being generated via a resistor-capacitor (RC) oscillator clock.
